(19) United States
(12) Patent Application Publication
(10) Pub. No.: US 2008/0261737 A1
(43) Pub. Date: Oct. 23, 2008

(54) Hydraulic tensioner

(75) Inventors: Osamu Yoshida, Osaka (JP); Hiroshi Hashimoto, Osaka (JP); Tsutomu Namie, Osaka (JP); Hiroyuki Miyake, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/998,517

(22) Filed: Nov. 30, 2007

(30) Foreign Application Priority Data
Feb. 2, 2007 (JP) 2007/024887

(51) Int. Cl. F16H 7/08

(52) U.S. Cl. 474/110

(57) ABSTRACT

A check valve unit in a hydraulic tensioner comprises a check ball, a steel ball guide having an inner wall allowing a limited range of longitudinal movement of the ball but restricting its lateral movement, a steel retainer attached to the high pressure oil chamber side of the ball guide, and a steel ball seat attached to the oil supply side of the ball guide. Bulged portions formed on an outer surface of the ball guide are press-fit into the plunger-accommodating hole of the tensioner.

### CROSS-REFERENCE TO RELATED APPLICATION

This application claims priority on the basis of Japanese application 2007-024887, filed Feb. 2, 2007. The disclosure of Japanese application 2007-024887 hereby incorporated by reference.

### FIELD OF THE INVENTION

The invention relates to a hydraulic tensioner, which applies proper tension to a timing belt, a timing chain, or the like, in a vehicle engine.

### BACKGROUND OF THE INVENTION

Hydraulic tensioners have been widely used to maintain tension in a timing belt or a timing chain which transmits rotation between a crankshaft and one or more camshaft in a vehicle engine. A hydraulic tensioner includes a check valve for suppressing vibration.

As shown in FIGS. 7 and 8, a conventional hydraulic tensioner 500 includes a plunger 520, slidably protruding from a plunger-accommodating hole 511 of a housing 510, a plunger biasing spring 530, accommodated in a high pressure oil chamber R formed between the plunger 520 and the bottom of the plunger-accommodating hole 511, for biasing the plunger 520 in the protruding direction, and a check valve unit 540, press-fit into a bottom portion of the plunger-accommodating hole 511. The check valve unit blocks reverse flow of oil from the high pressure oil chamber R.

The check valve unit 540, which is described in U.S. Patent Publication 2005/0227799, dated Oct. 13, 2005, comprises a check ball 541, which restricts the flow of oil, a synthetic resin ball guide, in which the check ball 541 moves, a disc-shaped retainer 543, attached to the ball guide by caulking on the entire outer circumferential portion of the high pressure oil chamber side of the ball guide. The retainer seals the check ball valve 541 in the ball guide 542. A ball seat cooperates with the check ball to blocks reverse flow of oil. The synthetic resin ball guide 542 is provided with an outer circumferential tongue 542b, which is press-fit into a bottom portion of the plunger-accommodating hole 511. A concave portion 543b for receiving and positioning the end of the plunger-biasing spring is formed on the high pressure oil chamber side of the ball guide.

Since, the ball guide 542 in the above-mentioned conventional hydraulic tensioner 500 is made of a synthetic resin, it is subject to elastic deformation due to high pressure in the high pressure oil chamber R, and to expansion and contraction due to changes in engine oil temperature. Elastic deformation and expansion and contraction of the ball guide can adversely affect the performance of the check valve unit, and there has been a need for a check valve capable of more stable and reliable performance in a hydraulic tensioner.

Among the objects of this invention are to solve the above-mentioned problems, to provide a hydraulic tensioner, having a more stable check valve mechanism and to provide a check valve unit that can be easily, and securely incorporated into a tensioner housing.

### SUMMARY OF THE INVENTION

The hydraulic tensioner according to the invention comprises a housing having a plunger-accommodating hole and a plunger. The plunger-accommodating hole has an inner circumferential wall symmetrical about an axis of the plunger-accommodating hole. A plunger is slidable in the plunger-accommodating hole, and protrudes therefrom so that it can apply tension to a traveling power transmission chain. The plunger and the plunger-accommodating hole define a high pressure oil chamber in the housing, which expands as the plunger moves in the protruding direction. The plunger-accommodating hole has a bottom opposite the plunger, and a bottom portion adjacent the bottom. A plunger biasing spring, disposed within the high pressure oil chamber, biases the plunger in its protruding direction. A check valve unit, incorporated within the bottom portion of the plunger-accommodating hole, permits flow of oil from a source of oil under pressure into the high pressure oil chamber, but prevents reverse flow of oil out of the high pressure oil chamber toward the source. The check valve unit comprises a check ball, a steel ball guide, a steel retainer, and a steel ball seat. The ball restricts flow of oil into the high pressure oil chamber. The ball guide has an outer circumferential surface and a wall surrounding the check ball. The wall has a longitudinal axis, and the ball guide allows the ball to move within the surrounding wall of the ball guide, within a range, along the longitudinal axis of the wall. The retainer is disposed on the side of the ball guide nearest the high pressure oil chamber, and has at least one opening for permitting oil to flow from within the wall of the ball guide to the high pressure oil chamber side of said ball guide. The retainer limits movement of the check ball toward the high pressure oil chamber. The ball seat is on the side of the ball guide remote from the high pressure oil chamber, and includes a flow passage for flow of oil from a source of oil under pressure into the high pressure oil chamber. The ball seat is engageable by the check ball to prevent reverse flow of oil out of the high pressure oil chamber toward the source. A plurality of bulging portions is formed on the outer circumferential surface of the ball guide. The bulging portions are press fit into the inner circumferential wall of the plunger-accommodating hole, and the ball seat is in contact with the bottom of the plunger-accommodating hole.

In a preferred embodiment of the hydraulic tensioner according to the invention, the ball guide has a concave portion on the side of the ball guide nearest the high pressure oil chamber. The concave portion has a cylindrical inner circumferential wall, in the form of a surface generated by movement of a straight line that is always parallel to the axis of said plunger-accommodating hole, and the retainer is press-fit into this concave portion of the ball guide.

Preferably, the ball guide has a concave portion on the side of the ball guide remote from the high pressure oil chamber, and the ball seat is press-fit into this concave portion on the side of the ball guide remote from the high pressure oil chamber.

The bulging portions are preferably disposed at equal intervals on the outer circumferential surface of said ball guide.

The hydraulic tensioner performs the functions of a conventional hydraulic tensioner, applying proper tension to a timing belt, chain or the like. In addition, because the steel ball guide has greater hardness, and a lower linear expansion coefficient, compared to the hardness and linear expansion coefficient of a synthetic resin ball guide, elastic deformation due to the pressure in the high pressure oil chamber, and expansion and contraction due to changes in the temperature of the engine oil, are suppressed, and the check valve unit exhibits improved stability. Furthermore, since the steel ball guide has a high degree of hardness, the check valve unit is more stably and reliably press-fit and fixed into the plunger-accommodating hole.

Since the retainer and ball seat are press-fit into ball guide, the check valve assembly can be handled as a unit, and easily incorporated into the bottom portion of the plunger-accommodating hole of a tensioner housing without danger of having the retainer or the ball seat drop off the ball guide.

Since the retainer-accommodating concave portion of the ball guide includes a cylindrical inner circumferential wall extending along the longitudinal direction of the plunger-accommodating hole, a large-diameter plunger-biasing spring can be stably disposed on the retainer. In contrast, in a conventional check valve unit, where the retainer is held in a resin ball guide by a part of the inner circumferential wall of the synthetic resin ball guide that overhangs a circumferential edge portion of the retainer, a high load exerted by the plunger-biasing spring cannot be sustained.

Where at least three bulged portions 142c are provided on the outer circumferential wall of the ball guide at equal angular intervals, the bulged portions reliably abut the inner circumferential wall of the plunger-accommodating hole, and the check valve unit can be accurately positioned at the center of the bottom portion of the plunger-accommodating hole, so that the check valve operates reliably.

The use of bulged portions also reduces the contact area between the inner circumferential wall of the plunger-accommodating hole and the outer circumferential wall of the ball guide. Therefore, the pressing force needed to press-fit the check valve unit into the bottom portion of the plunger-accommodating hole is reduced, and assembly of the tensioner is made easier. Moreover, wear of the inner circumferential wall of the plunger-accommodating hole and the outer circumferential wall of the ball guide is reduced.

### BRIEF DESCRIPTION OF THE DRAWINGS

FIG. 1 is an elevational view of a timing transmission of an internal combustion engine incorporating a hydraulic tensioner in accordance with the invention;

FIG. 2 is a cross-sectional view of the hydraulic tensioner shown in FIG. 1;

FIG. 3 is an enlarged, partially broken away, perspective view of a check valve unit in the tensioner of FIG. 2;

FIG. 4 is a top plan view in of the check valve unit;

FIG. 5 is an axial cross-section of the check valve unit;

FIG. 6 is a bottom plan view of the check valve unit;

FIG. 7 is a cross-sectional view of a conventional hydraulic tensioner; and

FIG. 8 is an enlarged, partially broken away, perspective view of a check valve unit of a conventional hydraulic tensioner.

### DETAILED DESCRIPTION OF THE PREFERRED EMBODIMENT

The hydraulic tensioner according to the invention is characterized by a check valve unit that is composed of a check ball, a steel ball guide, a steel retainer and a steel ball seat, by the fact that the outer wall of the ball guide has plural bulging portions that are press-fit into the plunger-accommodating hole of the tensioner, and by the fact that the ball seat is in contact with the bottom of the plunger-accommodating hole. The check valve unit avoids elastic deformation, expansion, and contraction, due to high pressure in the high pressure oil chamber and changes in engine oil temperature. It is capable of stable and reliable operation, and can be easily and securely incorporated into tensioner housing.

The invention can be embodied in a hydraulic tensioner with or without a ratchet mechanism. Although the material of the ball guide can be a metal such as aluminum or the like, having a high degree of hardness and a low linear expansion coefficient, steel is a preferred material for the ball guide, since steel exhibits low elastic deformation due to pressure in the high pressure oil chamber, and low expansion and contraction due to changes in engine oil temperature. The number of the bulged portions provided on the outer circumferential wall of the ball guide can be any number including, or greater than, two. However, providing at least three bulged portions is preferred.

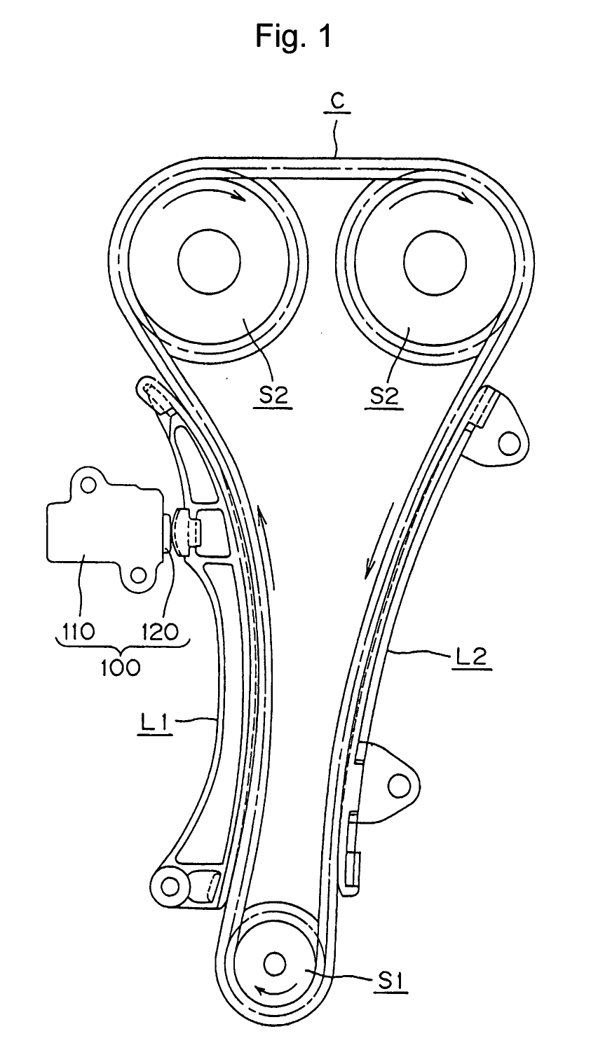

As shown in FIG. 1, a hydraulic tensioner 100 is mounted on an engine body (not shown) adjacent the slack side of a timing chain C, that moves from a driving crankshaft sprocket S1, toward a pair of driven camshaft sprockets S2. A plunger 120 of the tensioner protrudes from a tensioner housing 110, and presses against a back surface of a tensioner lever L1 pivotably supported on the engine body at a location remote from the lever's pivot axis. Thus, tension is applied to the slack side of the timing chain C through the lever L1. A fixed guide L2 is typically in sliding contact with the tension side of the timing chain.

The sprockets rotate, and the timing chain C travels, in directions indicated by arrows, and the rotation of the driving sprocket S1 is transmitted by the chain to the driven sprockets S2.

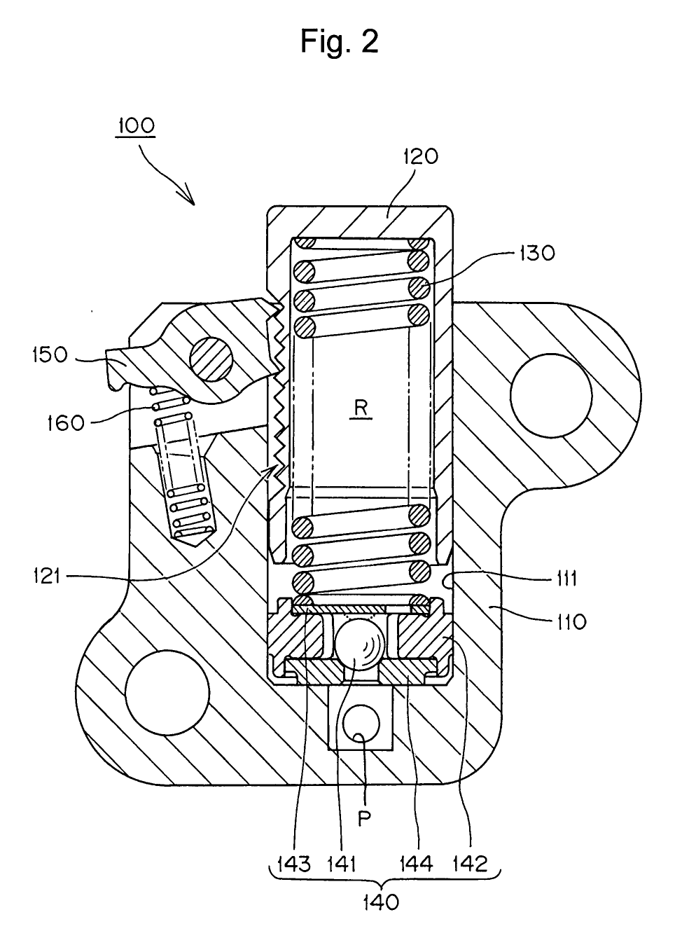

As shown in FIG. 2, a hollow plunger 120 fits slidably in a plunger-accommodating hole 111 formed in the tensioner housing 110, and, with the tensioner housing, forms a high pressure oil chamber R, part of which is inside the hollow plunger, and another part of which is between the plunger and the bottom of the plunger-accommodating hole 111. A plunger biasing coil spring 130 urges the plunger 120 in a protruding direction.

A rack formed 121 formed on the plunger 120 is engageable by a ratchet pawl 150 pivoted to the tensioner housing 110 and biased toward engagement with the rack by a spring 160. The engagement between the pawl 150 and the rack 121 on the plunger 120 blocks retracting movement of the plunger.

A check valve unit 140 is disposed within the bottom portion of the plunger-accommodating hole 111 for allowing oil to flow from an oil supply passage P into the high pressure oil chamber, and for blocking reverse flow of oil out of the high pressure oil chamber. The check valve unit 140 is fixed to the inside of the plunger-accommodating hole by press-fitting.

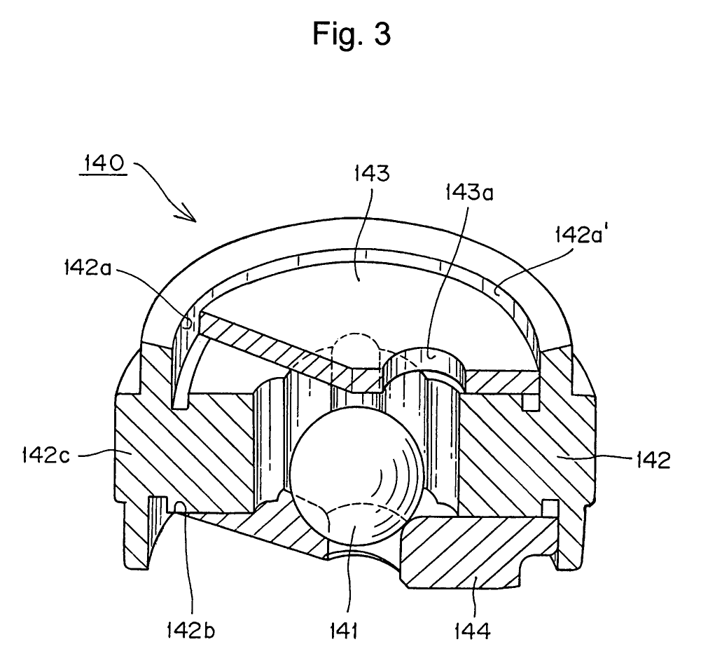

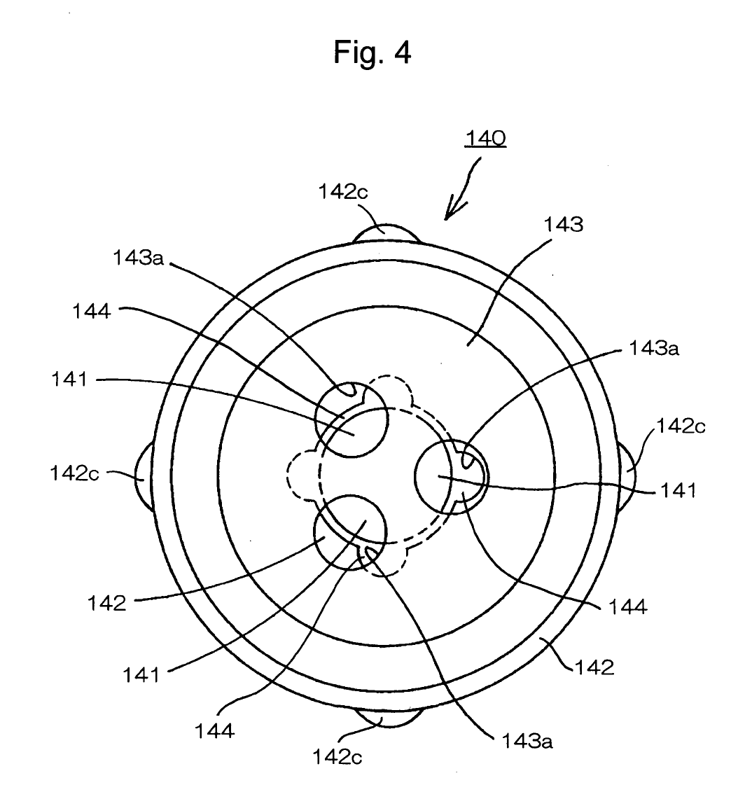

As shown in FIGS. 3-6, the check valve unit 140 comprises a check ball 141, which restricts the flow of oil through the check valve unit, and a steel ball guide 142 having an inner wall which loosely surrounds the ball, allowing the ball to move longitudinally but restricting its lateral movement. The inner wall of the ball guide is preferably formed with longitudinal grooves in order to allow free flow of oil past the ball, while the portions of the inner wall of the ball guide between the grooves limit lateral movement of the ball. A steel retainer 143, provided with oil communicating holes 143a, is attached to a high pressure oil chamber side of the ball guide 142, and allows oil to flow into the high pressure oil chamber while maintaining the check ball 141 sealed in the ball guide 142. These oil communicating holes in the retainer are preferably arranged, as shown in FIG. 4, so that at least parts of at least some of the grooves are in register with oil communicating holes in the retainer, thereby ensuring that the retainer does not excessively restrict the flow of oil through the check valve mechanism. A steel ball seat 144 is attached to the ball guide 142 on the oil supply side of the ball guide. The ball seat cooperates with the check ball 141 to block reverse flow of the oil from the high pressure oil chamber to the oil supply passage P.

The retainer 143 fits into a concave recess 142a formed on the high pressure oil chamber side of the ball guide 142, the recess having a cylindrical inner circumferential wall 142a′. The inner circumferential wall 142a′ is in the form of a cylindrical surface, i.e., a surface generated by movement of an imaginary straight line in a closed path while the imaginary straight line remains parallel to longitudinal direction of the plunger-accommodating hole 111. The retainer 143 is press-fit into the concave recess 142a of the ball guide.

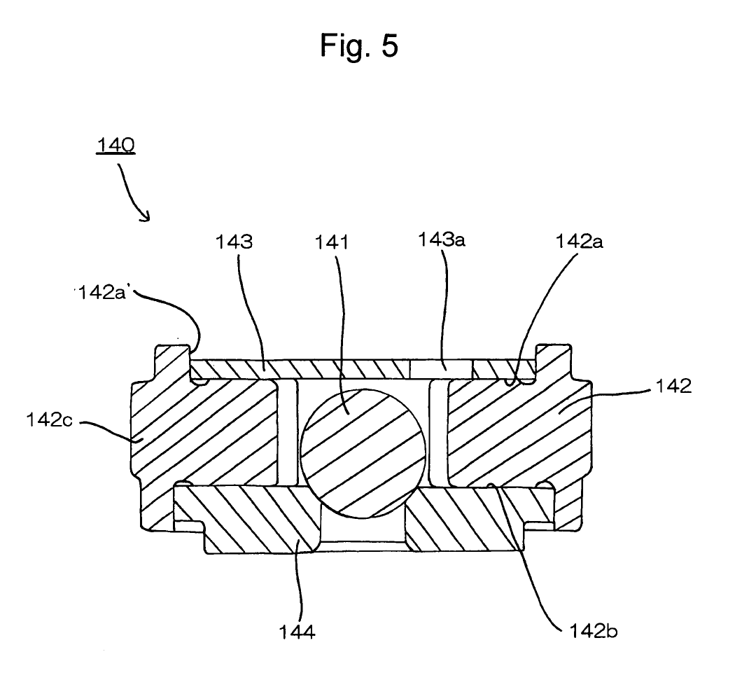

As shown in FIG. 5, a concave, ball seat-accommodating recess 142b is formed in the oil supply side of ball guide 142, and a ball seat 144 is press-fit into recess 142b.

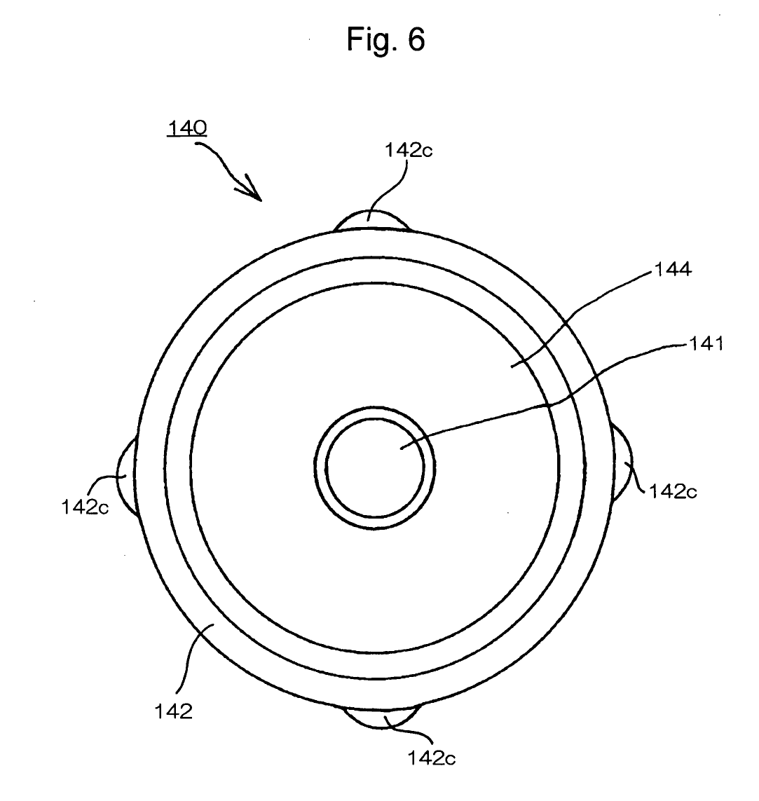

As shown in FIGS. 4 and 6, Four bulged portions 142c are formed on the outer circumferential wall of the ball guide 142. These bulged portions 142c are press-fit into the inner circumferential wall of the plunger-accommodating hole 111 at the bottom portion of the hole 111, and the ball seat is in contact with the bottom of the plunger-accommodating hole. The bulged portions are preferably disposed at equal angular intervals, 90° in this case, about the ball guide.

Compared to a conventional synthetic resin ball guide, the steel ball guide 142 has a higher hardness and a lower linear expansion coefficient. Consequently, elastic deformation due to high pressure in oil chamber R, and expansion and contraction due to changes in engine oil temperature, are suppressed. Consequently, the check valve unit 140 can exhibit a stable check valve function. Moreover, since the steel ball guide 142 has a high degree of hardness, the check valve unit 140 is reliably fixed in and the plunger-accommodating hole 111 by press-fitting.

The use of bulged portions 142c reduces the contact area between the inner circumferential wall of the plunger-accommodating hole 111 and the outer circumferential wall of the ball guide 142. Therefore, the pressing force needed to press-fit the check valve unit 140 the bottom portion of the plunger-accommodating hole 111 is reduced, and assembly of the tensioner is made easier. Moreover, wear of the inner circumferential wall of the plunger-accommodating hole 111 and the outer circumferential wall of the ball guide 142 is reduced.

Since the retainer and ball seat are press-fit into ball guide, the check valve assembly can be handled as a unit, and easily incorporated into the bottom portion of the plunger-accommodating hole 111 of the tensioner housing without danger of having the retainer or the ball seat drop off the ball guide.

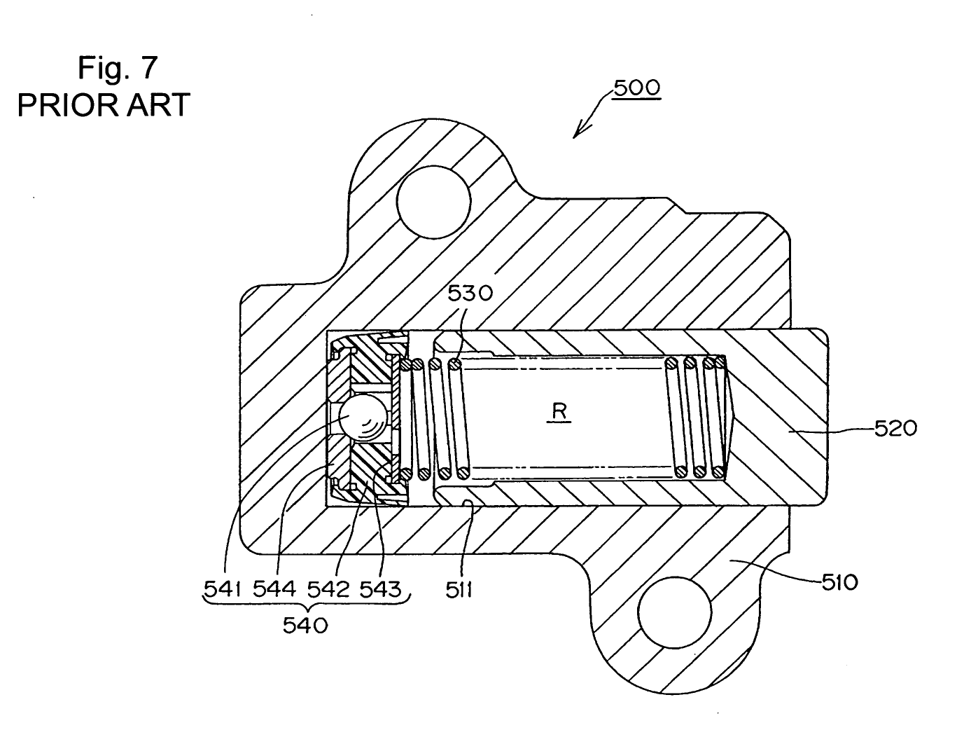

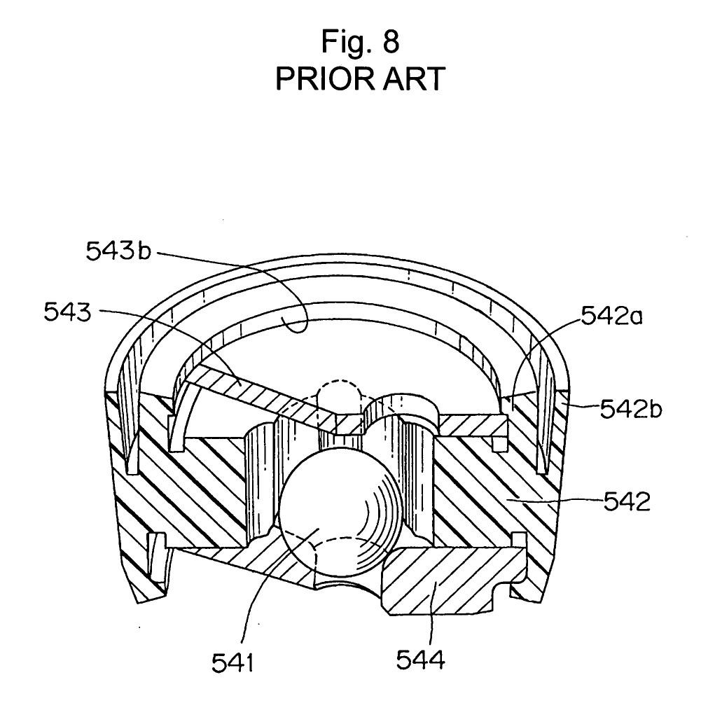

Since the retainer-accommodating concave portion 142a of the ball guide includes a cylindrical inner circumferential wall extending along the longitudinal direction of the plunger-accommodating hole 120, a large-diameter plunger-biasing spring 130 can be stable disposed on the retainer 143. In contrast, in a conventional check valve unit as shown in FIGS. 7 and 8, where the retainer is held in a resin ball guide by a part of the inner circumferential wall of the synthetic resin ball guide 542 that overhangs a circumferential edge portion of the retainer 543, a high load exerted by the plunger-biasing spring cannot be sustained.

Where at least three, and preferably four, bulged portions 142c are provided on the outer circumferential wall of the ball guide 142 at equal angular intervals, the bulged portions reliably abut the inner circumferential wall of the plunger-accommodating hole 111, and the check valve unit 140 can be accurately positioned at the center of the bottom portion of the plunger-accommodating hole 111, so that the check valve operates reliably.

What is claimed is:

1. A hydraulic tensioner comprising:
a housing having a plunger-accommodating hole having an inner circumferential wall symmetrical about an axis of said plunger-accommodating hole;
a plunger, slidable in said plunger-accommodating hole, and protruding therefrom, for applying tension to a traveling power transmission chain, the plunger and the plunger-accommodating hole defining a high pressure oil chamber in said housing which expands as the plunger moves in the protruding direction, the plunger-accommodating hole having a bottom opposite said plunger, and a bottom portion adjacent said bottom, the bottom portion of the plunger-accommodating hole being disposed adjacent said bottom of the plunger-accommodating hole;
a plunger biasing spring, disposed within said high pressure oil chamber, the spring biasing the plunger in said protruding direction; and
a check valve unit incorporated within said bottom portion of said plunger-accommodating hole, the check valve unit permitting flow of oil from a source of oil under pressure into said high pressure oil chamber, but preventing reverse flow of oil out of said high pressure oil chamber toward said source;
said check valve unit comprising:
a check ball which restricts the flow of oil into said high pressure oil chamber;
a steel ball guide having an outer circumferential surface and a wall surrounding the check ball, said wall having a longitudinal axis, the ball guide allowing the ball to move within said surrounding wall, within a range, along said longitudinal axis of the wall, the ball guide having a side nearest the high pressure oil chamber and a side remote from the high pressure oil chamber;
a steel retainer on a side of the ball guide nearest the high pressure oil chamber, the retainer having at least one opening for permitting oil to flow from within the wall of the ball guide into said high pressure oil chamber side of said ball guide, the retainer limiting movement of the check ball toward said high pressure oil chamber;
a steel ball seat on a side of the ball guide remote from the high pressure oil chamber, the ball seat including a flow passage for flow of oil from said source of oil under pressure into said high pressure oil chamber, and being engageable by said check ball to preventing reverse flow of oil out of said high pressure oil chamber toward said source; and
a plurality of bulging portions formed on the outer circumferential surface of the ball guide, said bulging portions being press fit into the inner circumferential wall of said plunger-accommodating hole, and said ball seat being in contact with the bottom of the plunger-accommodating hole.

2. A hydraulic tensioner according to claim 1, in which said ball guide has a concave portion on said side of the ball guide nearest the high pressure oil chamber, said concave portion having an inner circumferential wall in the form of a cylindrical surface generated by movement of a straight line always parallel to the axis of said plunger-accommodating hole, and in which said retainer is press-fit into said concave portion of the ball guide.

3. A hydraulic tensioner according to claim 1, in which said ball guide has a concave portion on said side of the ball guide remote from the high pressure oil chamber, and in which said ball seat is press-fit into said concave portion on said side of the ball guide remote from the high pressure oil chamber.

4. A hydraulic tensioner according to claim 2, in which said ball guide has a concave portion on said side of the ball guide remote from the high pressure oil chamber, and in which said ball seat is press-fit into said concave portion on said side of the ball guide remote from the high pressure oil chamber.

5. A hydraulic tensioner according to claim 1, in which said bulging portions are disposed at equal intervals on said outer circumferential surface of said ball guide.

6. A hydraulic tensioner according to claim 2, in which said bulging portions are disposed at equal intervals on said outer circumferential surface of said ball guide.

7. A hydraulic tensioner according to claim 3, in which said bulging portions are disposed at equal intervals on said outer circumferential surface of said ball guide.

8. A hydraulic tensioner according to claim 4, in which said bulging portions are disposed at equal intervals on said outer circumferential surface of said ball guide.
